(19) United States
(12) Patent Application Publication
(10) Pub. No.: US 2003/0204783 A1
(43) Pub. Date: Oct. 30, 2003

(54) Repair analyzer of dram in semiconductor integrated circuit using built-in CPU

(76) Inventor: Sachie Kuroda, Tokyo (JP)

Correspondence Address: BURNS, DOANE, SWECKER & MATHIS, L.L.P., P.O. Box 1404, Alexandria, VA, 22313-1404, US

(21) Appl. No.: 10/291,663

(22) Filed: Nov. 12, 2002

(30) Foreign Application Priority Data
Apr. 30, 2002 (JP) 2002-129071

(51) Int. Cl. H02H 3/05

(52) U.S. Cl. 714/35

(57) ABSTRACT

A semiconductor integrated circuit includes a DRAM memory array to be tested, an algorithmic pattern generator (ALPG), a CPU and an SRAM for the CPU. The ALPG writes data to and reads the data from the DRAM memory array when the operation mode is set at a test mode. Reading the data held in the memory cell when the ALPG writes the data to and reads the data from the memory cell, the CPU locates a defective portion in the DRAM memory array, and analyzes a redundancy section for replacing the defective portion. The SRAM stores the execution code of the operation of the CPU in the test mode, defective decision result and analysis result. The semiconductor integrated circuit can reduce the circuit scale by simplifying the configuration associated with the test function with maintaining the advantages of the real-time test.

### BACKGROUND OF THE INVENTION

1. Field of the Invention

The present invention relates to a semiconductor integrated circuit such as a system LSI, and more particularly to a repair analyzer of a DRAM in a semiconductor integrated circuit using a central processing unit (CPU) built in the semiconductor circuit.

2. Description of Related Art

FIG. 9 is a block diagram showing a schematic configuration of a conventional semiconductor integrated circuit including a BIST (Built-in Self Test) circuit of a DRAM; and FIG. 10 is a block diagram showing a configuration for carrying out the repair analysis of the DRAM by the BIST circuit of FIG. 9. In these figures, the reference numeral 100 designates a semiconductor integrated circuit including a DRAM core 101, a BIST circuit 104 and a logic circuit 107 integrated in one chip. The DRAM core 101 comprises a DRAM memory array including memory cells disposed at the intersections of word lines and bit lines, column/row decoders for selecting a memory cell on the DRAM memory array, word drivers, bit line selectors, and sense amplifiers for amplifying data read from the memory cells. The DRAM core 101 includes spare rows and a spare row decoder, and spare columns and a spare column decoder to repair a defective memory cell in the DRAM memory array.

The reference numeral 102 designates an ALPG (ALgorithmic Pattern Generator) memory that stores test vectors and access pattern programs for carrying out test of the DRAM memory array utilizing the test vectors. The test vectors are a program describing input vectors and expected output vectors (expected values) in a test program language. The access pattern programs (main program) are a program describing operation control procedures of the individual blocks associated with the test functions during the test. Executing the access pattern program by an ALPG 103 enables the test vectors to be used as the test patterns consisting of the input signal sequence and its expected response output signal sequence (expected value data) in accordance with test specifications. The test patterns and the access pattern programs constitute the test program.

The ALPG 103 generates addresses and data for the DRAM test using an arithmetic unit. It generates test pattern data with a specified bit pattern by executing the test program, and writes the test pattern data into the memory cells in the DRAM core 101. The BIST circuit 104 includes the ALPG memory 102, the ALPG 103, a repair analyzer 105 and a repair analysis memory 106. The repair analyzer 105 makes a decision as to whether the test pattern data written into the DRAM memory cell array by the ALPG 103 is read correctly or not, and generates compressed information RD of the information about a defective memory cell. The repair analyzer 105 includes a comparator for logically comparing the output data with the expected values of the DRAM, and a test output compressor for compressing the failure information. As the test output compressor, hardware in conformity with the test specifications is used. It usually includes a counter and an LFSR (Linear Feedback Shift Register).

The repair analysis memory 106 is composed of an SRAM, and stores the compressed information about defective memory cells obtained as the result of the test over the entire memory area of the DRAM. The logic circuit 107 comprises a CPU 108, an SRAM 109 and a control register used for deciding an operation mode and storing instruction codes from the CPU 108, and executes arithmetic and logic operations of the semiconductor integrated circuit 100. The SRAM 109, a memory for the CPU 108, temporarily stores the execution codes of the user program. The reference numeral 110 designates a write circuit for writing the access pattern program, which is read from an external test device such as an LSI tester, into the ALPG memory 102. The reference numeral 111 designates LT-fuses that undergo laser trimming for the defective repair.

Next, the operation of the conventional semiconductor integrated circuit will be described.

First, the write circuit 110 writes the access pattern program, which meets the test specifications and is sent from the external test device such as the LSI tester, into the ALPG memory 102 that stores a plurality of test vectors corresponding to various test modes. Subsequently, when a logic level indicating the start of the test is written into a specified bit of the control register (not shown) in the BIST circuit 104, the ALPG 103 reads the test program from the ALPG memory 102, and generates access timings and test pattern data corresponding to the test program, thereby starting the access to the DRAM memory array. Assume that the ALPG 103 iterates the read/write access to a particular memory cell of the DRAM memory cell array.

Specifically, in the write access, the ALPG 103 generates an address signal for specifying the address of the memory cell in which the data is to be written along the access timing described by the access pattern program, and supplies the address signal to the column/row decoders in the DRAM core 101. The column/row decoders decode the address signal from the ALPG 103, and convert it to the address information on the DRAM memory array. The address information is delivered to the word driver and bit line selector to select the memory cell in which the data is to be written. The ALPG 103 writes the test pattern data in the individual memory cells thus selected. In the read access, on the other hand, the ALPG 103 reads the data after selecting the memory cell in the same manner as described above.

Subsequently, when multiple times of accesses to each memory cell have been completed, the repair analyzer 105 detects the stored data of the memory cell specified by the address signal from the ALPG 103, and loads the data as the output data from the memory cell. Then, the repair analyzer 105 logically compares the output data with the expected value data supplied from the ALPG 103.

If the repair analyzer 105 decides that the memory cell is defective because the two data disagree, it obtains from the information about the defective memory cell a set of substitute addresses (redundancy repair solution) that decides a repair row or column for effectively repairing the defective memory cell in the DRAM memory array. The information about the defective memory cell (referred to as “failure information” from now on) includes address information for specifying the address of the defective memory cell on the DRAM memory array and an index representing the defective state. As a typical index representing the defective state, there is bit data indicating whether the two data agree with each other at only a high level or a low level for the multiple times of accesses, or at the two levels (high impedance).

According to the redundancy repair solution obtained about the defective memory cell, the repair analyzer 105 generates the compressed information by compressing the failure information on a repair unit basis. For example, when the DRAM memory array is configured such that it carries out redundant repair on a bit line by bit line basis including the defective memory cell, the data compression is implemented by replacing the failure information about a plurality of memory cells with different addresses on the same line by a single piece of data. The compressed information thus obtained is stored in the repair analysis memory 106 as a series of operations in the read access.

Thus, the repair analyzer 105 conducts the test of all the memory cells of the DRAM memory array to be tested, and stores the detected failure information sequentially in the repair analysis memory 106 as the compressed information.

When the test has been completed of all the memory cells of the DRAM memory array to be tested, a logic value indicating the end of the test is written into a particular bit in the control register (not shown) in the BIST circuit 104, thereby completing the test. Subsequently, the repair analyzer 105 causes the CPU 108 in the logic circuit 107 to analyze the compressed information stored in the repair analysis memory 106, thereby obtaining the repair code indicating the location of the LT-fuse 111 to be subjected to laser trimming. The external test device such as an LSI tester reads the repair code to replace the defectives.

With the foregoing configuration, the conventional semiconductor integrated circuit has a problem of inevitably increasing the circuit scale because of the presence of the repair analysis memory 106 and repair analyzer 105 used only for the test.

For example, the repair analyzer 105 must store individual items of the failure information on the memory cells corresponding to the internal addresses of the DRAM memory array one by one. This corresponds to reproduce the failure information in the DRAM memory array on the repair analysis memory 106. Therefore, it is necessary for the repair analysis memory 106 to have a memory capacity corresponding to the number of addresses of the DRAM memory array, from which the test information must be captured, regardless of the number of pieces of the failure information. Thus, the semiconductor integrated circuit must include another built-in memory with about the same memory capacity.

### SUMMARY OF THE INVENTION

The present invention is implemented to solve the foregoing problem. It is therefore an object of the present invention to provide a semiconductor integrated circuit capable of reducing the circuit scale by simplifying the configuration for the test by carrying out the repair analysis of the semiconductor memory by a CPU using software with maintaining the advantages of the real-time test.

According to one aspect of the present invention, there is provided a semiconductor integrated circuit including: a semiconductor memory including a redundancy section for replacing a defective portion; a test access section for writing test data to and reading the test data from each memory cell in the semiconductor memory in a test mode; a central processing unit for analyzing the redundancy section for replacing the defective portion by rereading data held in the memory cell when the test data is written to and read data from the memory cell; and a storing section for storing the test result by the central processing unit.

Thus, the foregoing semiconductor integrated circuit can offer an advantage of being able to reduce the circuit scale with keeping the advantages of the real-time test.

### BRIEF DESCRIPTION OF THE DRAWINGS

FIG. 1 is a block diagram showing a schematic configuration of an embodiment 1 of the semiconductor integrated circuit in accordance with the present invention;

FIG. 2 is a block diagram showing a configuration for carrying out the repair analysis of the DRAM in the semiconductor integrated circuit in FIG. 1;

FIG. 3 is a flowchart illustrating the operation of the semiconductor integrated circuit in FIG. 1;

FIG. 4 is a block diagram showing a schematic configuration of an embodiment 2 of the semiconductor integrated circuit in accordance with the present invention;

FIG. 5 is a block diagram showing a configuration for carrying out the repair analysis of the DRAM in the semiconductor integrated circuit in FIG. 4;

FIG. 6 is a flowchart illustrating the operation of the semiconductor integrated circuit in FIG. 4;

FIG. 7 is a block diagram showing a schematic configuration of an embodiment 3 of the semiconductor integrated circuit in accordance with the present invention;

FIG. 8 is a block diagram showing a configuration for carrying out the repair analysis of the DRAM in the semiconductor integrated circuit in FIG. 7;

FIG. 9 is a block diagram showing a schematic configuration of a conventional semiconductor integrated circuit; and

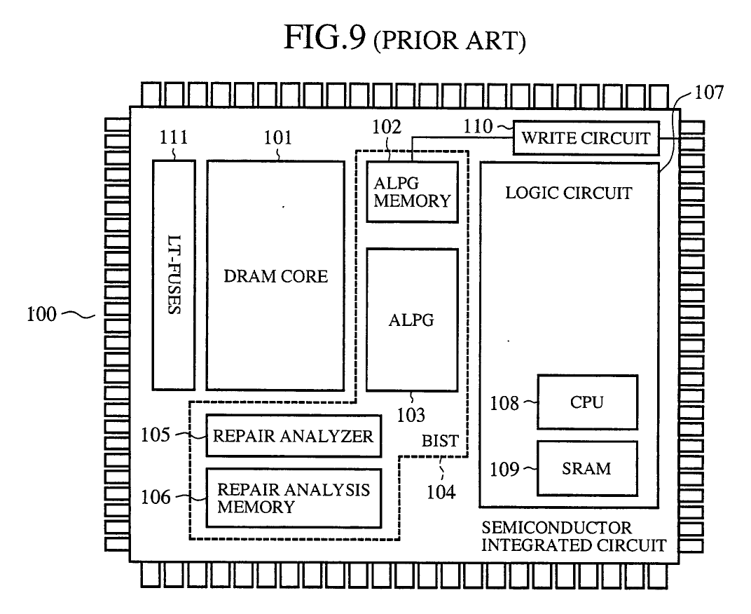

FIG. 10 is a block diagram showing a configuration for carrying out the repair analysis of the DRAM by the BIST circuit in FIG. 9.

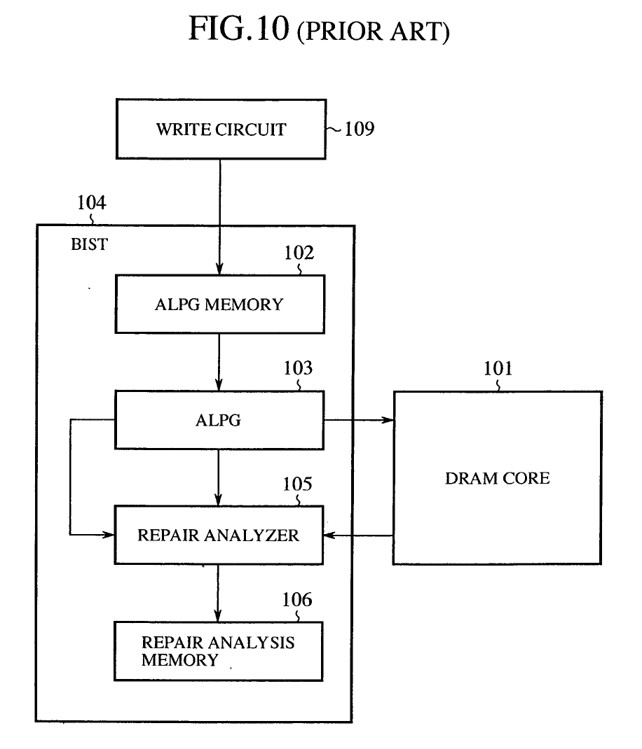

### DETAILED DESCRIPTION OF THE PREFERRED EMBODIMENTS

The invention will now be described with reference to the accompanying drawings.

Embodiment 1

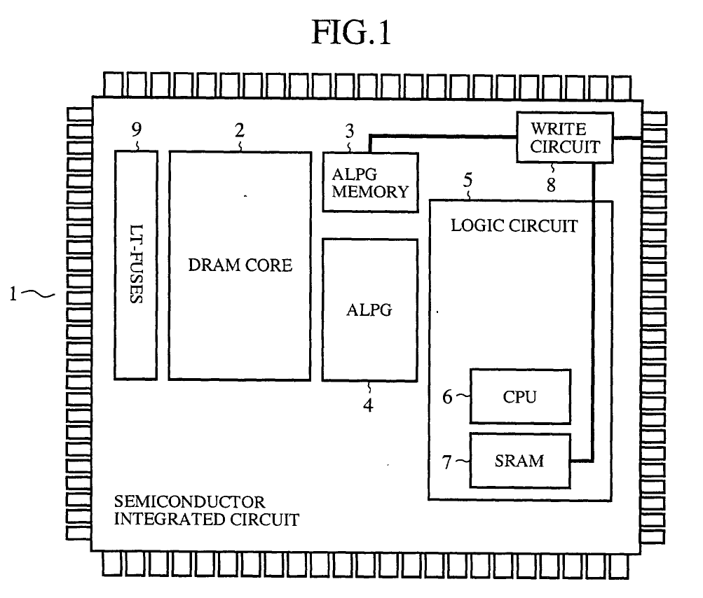

FIG. 1 is a block diagram showing a schematic configuration of an embodiment 1 of the semiconductor integrated circuit in accordance with the present invention. In FIG. 1, the reference numeral 1 designates a semiconductor integrated circuit comprising a DRAM core 2, an ALPG memory 3, an ALPG 4 and a logic circuit 5 in a single chip. The DRAM core 2 comprises a DRAM memory array including memory cells disposed at the intersections of word lines and bit lines, column/row decoders for selecting a memory cell on the DRAM memory array, word drivers, bit line selectors, and sense amplifiers for amplifying data read from the memory cells. The DRAM core 2 includes spare rows and a spare row decoder, and spare columns and a spare column decoder to repair a defective memory cell in the DRAM memory array.

The ALPG (ALgorithmic Pattern Generator) memory 3 for storing execution code (what is called the machine code) of the ALPG 4 stores test vectors and access pattern programs for testing the DRAM memory array utilizing the test vectors. The test vectors are a program describing input vectors and expected output vectors (expected values) in a test program language. The access pattern programs (main programs) are a program describing operation control procedures of the individual blocks associated with the test functions during the test. Executing the access pattern programs by the ALPG 4 enables the test vectors to be used as the test patterns consisting of the input signal sequence and its expected response output signal sequence (expected value data) meeting test specifications. The test patterns and the access pattern programs constitute the test program.

The ALPG 4 generates addresses and data for the DRAM test using an arithmetic unit. It generates test pattern data with a specified bit pattern by executing the test program, and writes the test pattern data into the memory cells in the DRAM core 2. The logic circuit 5, which carries out the logic and arithmetic processing of the semiconductor integrated circuit 1, comprises a CPU 6, an SRAM 7, a control register for storing a decided operation mode and instruction code fed from the CPU 6, and a selector for obtaining address information at the compression. The CPU 6 executes user programs stored in a ROM not shown in FIG. 1 in a normal mode, and carries out the repair analysis of the DRAM in a test mode.

The SRAM 7 temporarily stores the execution code of ordinary user programs to be performed by the CPU 6. It also stores the test program, repair analysis program, and compressed information and repair code of the failure information obtained by the repair analysis. The reference numeral 8 designates a write circuit for reading the test program from an external test device such as an LSI tester, and writes it to the ALPG memory 3 and SRAM 7. The reference numeral 9 designates LT-fuses to be subjected to laser trimming at the time when the repair function is carried out.

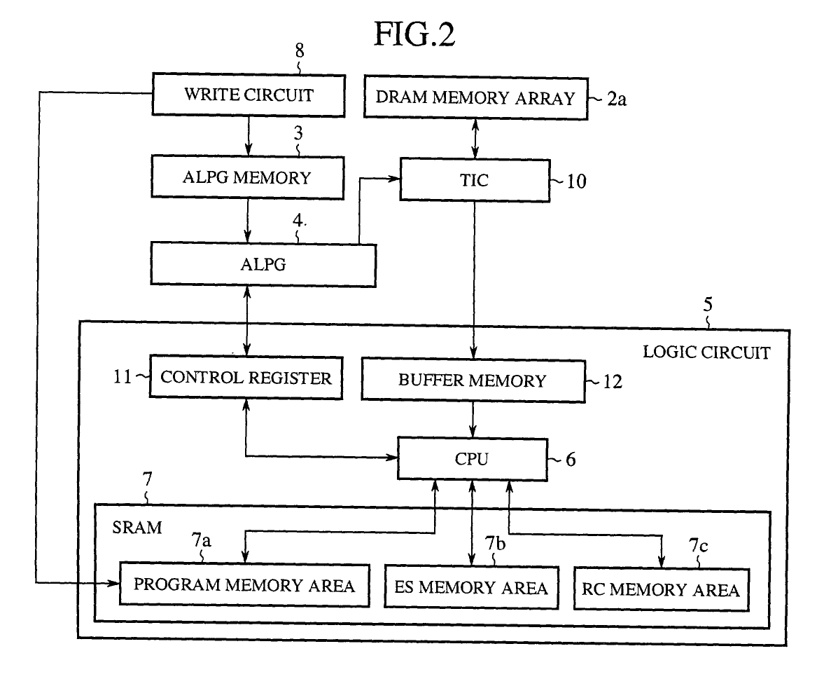

FIG. 2 is a block diagram showing a configuration for carrying out the repair analysis of the DRAM in the semiconductor integrated circuit in FIG. 1. In FIG. 2, the reference numeral 2a designates the DRAM memory array constituting the DRAM core 2. The DRAM memory array 2a undergoes data write and data read via a TIC (Test Interface Circuit) 10 in the test mode. The reference numeral 7a designates a program memory area provided in the SPAM 7. The program memory area 7a temporarily stores the execution code of the program of the CPU 6, and stores the test program and repair analysis program supplied by the write circuit 8. The reference numeral 7b designates an ES memory area (error-storage memory area) provided in the SRAM 7 for storing the failure information obtained by the DRAM test by the CPU 6. The reference numeral 7c designates an RC memory area (repair code memory area) provided in the SRAM 7 for storing the repair code obtained from the failure information by the CPU 6.

The TIC (Test Interface Circuit) 10 transfers the input and output data between the logic circuit 5 and the DRAM memory array 2a to be tested. The reference numeral 11 designates the control register for storing the decided operation mode of the semiconductor integrated circuit 1 and the instruction code fed from the CPU 6. The reference numeral 12 designates a buffer memory for temporarily storing the data obtained by executing the programs by the CPU 6. In FIG. 2, the same components as those of FIG. 1 are designated by the same reference numerals and the description thereof is omitted here.

Next, the operation of the present embodiment 1 will be described.

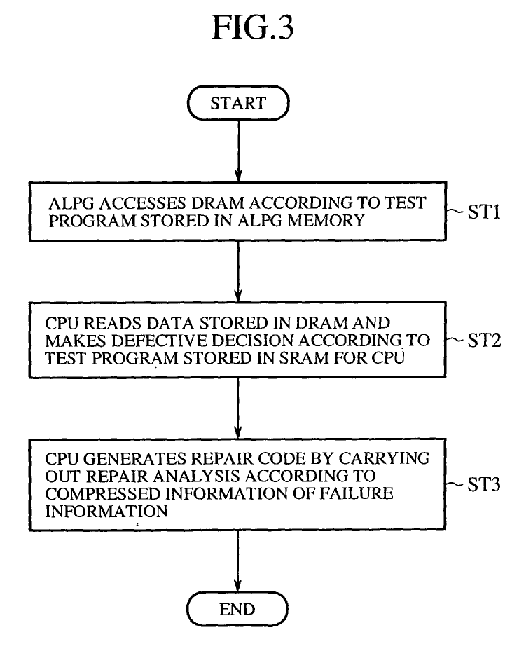

FIG. 3 is a flowchart illustrating the operation of the semiconductor integrated circuit in FIG. 1, with reference to which the repair analysis of the DRAM will be described.

First, the write circuit 8 loads the information necessary for the test such as the test program in accordance with the test specification from the external test device such as the LSI tester. Subsequently, the write circuit 8 writes the input test program in the ALPG memory 3 and program memory area 7a in the SRAM 7 as the execution code of the ALPG 4 and CPU 6. The write operation is performed in accordance with the data write rate of the external test device.

Subsequently, receiving the test start request from the outside, the CPU 6 sets into the specified bits of the control register 11 the logic values designating the access pattern program and test vector in accordance with the test specification corresponding to the request, and the logic value designating the start of the test. Thus, the ALPG 4 reads the test program corresponding to the specification from the ALPG memory 3 and executes it, and accesses the DRAM memory array 2a by generating access timings and test pattern data according to the test program (step STI). It is assumed here that the ALPG 4 iterates the read/write access to each memory cell of the DRAM memory cell array.

Specifically, in the write access, the ALPG 4 generates the address signal for specifying the address of the memory cell to which the data is to be written along the write access timing described by the access pattern program, and delivers it to the column/row decoders in the DRAM core 2. The column/row decoders decode the address signal from the ALPG 4, and convert it to the address information about the DRAM memory array. The address information is delivered to the word drivers and bit line selectors to select the memory cell to which the data is to be written. The ALPG 4 writes the test pattern data to each memory cell thus selected. In contrast, in the read access, after selecting the memory cell as described above, the ALPG 4 reads the data.

If the DRAM memory cell is defective, a piece of defective data is written in the DRAM memory cell by the ALPG 4. In other words, the DRAM memory cell holds the defective data even after the ALPG 4 has made an access. Let us consider the case where the ALPG 4 places the DRAM memory cell at the high level by the write access, but the potential of the memory cell drops because of a leakage current greater than a specified value owing to a failure of the memory cell.

In this case, when the ALPG 4 places the word line at the high level to read the data, the MOS transistor of the memory cell becomes conductive, and the potential held by the memory cell drops further because of the parasitic capacitance of the bit line. When the sense amplifier reads the charges on the bit line as the stored data of the memory cell in this state, its decision value will assume the opposite phase. Thus, the stored data of the memory cell will be read as low level data by the read access of the ALPG 4.

Even if the correct data is written into the memory cell thereafter, the defective state is reproduced by the read access as describe above. Accordingly, the defective state is maintained even after the access by the ALPG 4. As a result, even if the CPU 6 accesses the DRAM memory cell after the ALPG 4 has completed the access, it can read the defective state of the memory cell.

After the ALPG 4 has completed the series of accesses to the DRAM, the CPU 6 analyzes the test program set in the program memory area 7a, thereby obtaining the relationships between the DRAM memory cell and the expected value of the response output. Then, the CPU 6 rereads the data written into the DRAM memory array 2a using the address information. The data sequentially read from the memory cell are temporarily stored in the buffer memory 12.

Subsequently, the CPU 6 reads the output data of the DRAM memory cell sequentially from the buffer memory 12, and compares them with the expected values of the corresponding response output. If they disagree, the CPU 6 makes a decision that the memory cell is defective, and sequentially stores the failure information in the ES memory area 7b in the SRAM 7 (step ST2: defective decision step).

Thus detecting a defect in the DRAM memory cell, the CPU 6 executes the repair analysis program stored in the program memory area 7a separately from the test program, thereby obtaining from the contents stored in the ES memory area 7b a set of the substitute addresses (redundancy repair solution) that decides the row or column for efficiently repair the defective memory cell in the DRAM memory array 2a.

According to the redundancy repair solution obtained for the defective memory cell, the CPU 6 generates the compressed information by compressing the failure information into the repair unit. For example, when the DRAM memory array 2a has a configuration that carries out the redundant repair on a bit line basis including the defective memory cell, the failure information about a plurality of memory cells with different addresses on the same line can be compressed by replacing the failure information by a piece of data. The compressed information thus obtained is stored in the ES memory area 7b in the series of the operations in the read access.

Subsequently, the CPU 6 carries out the test of all the memory cells (including the spare cells) of the DRAM memory array 2a to be tested, and sequentially stores the failure information in the ES memory area 7b as the compressed information.

Completing the test of all the memory cells of the DRAM memory array 2a to be tested, the CPU 6 analyzes the compressed information stored in the ES memory area 7b to obtain the repair code (including the repair code for the spare cells) for designating the location in the LT-fuses 9 to be subjected to the laser trimming (step ST3: repair analysis step). The repair code is stored in the RC memory area 7c of the SRAM 7.

Subsequently, the repair code in the RC memory area 7c is read by the external test device such as the LSI tester to carry out the actual defective repair.

In this way, the fast test and repair analysis of the DRAM is carried out through two independent stages: the access to the DRAM by the ALPG 4; and the repair analysis by the CPU 6. Accordingly, it is only the initial data write to the ALPG memory 3 and SRAM 7, and the final read of the repair code that the external test device such as the LSI tester carries out at a low speed. In other words, a low speed, inexpensive tester can achieve the high speed processing.

As described above, the present embodiment 1 is configured such that the defective decision and repair analysis of the DRAM memory cells, which are conventionally performed by the dedicated test circuit, are carried out using the software of the CPU 6 installed as standard equipment as the logic circuit 5 in connection with the SRAM 7 for storing the execution codes of the CPU 6 in the program processing. As a result, the present embodiment 1 can reduce the circuit scale with maintaining the advantages of the real-time test.

Embodiment 2

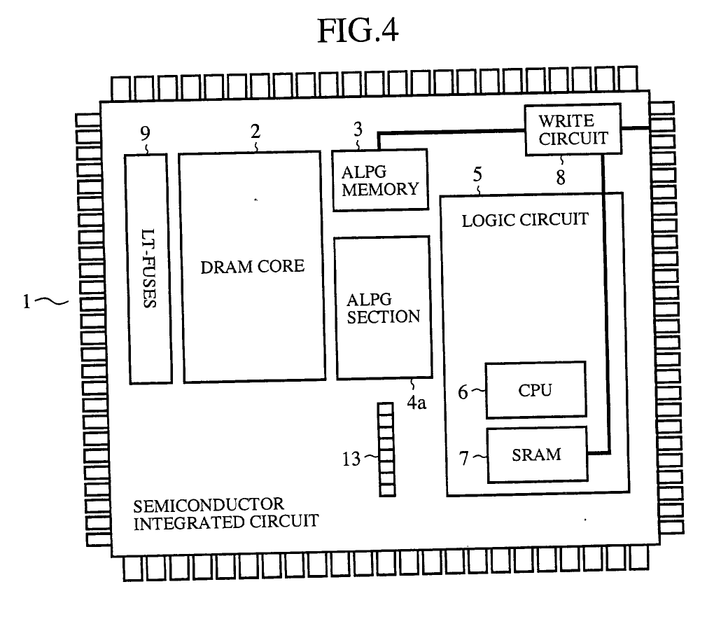

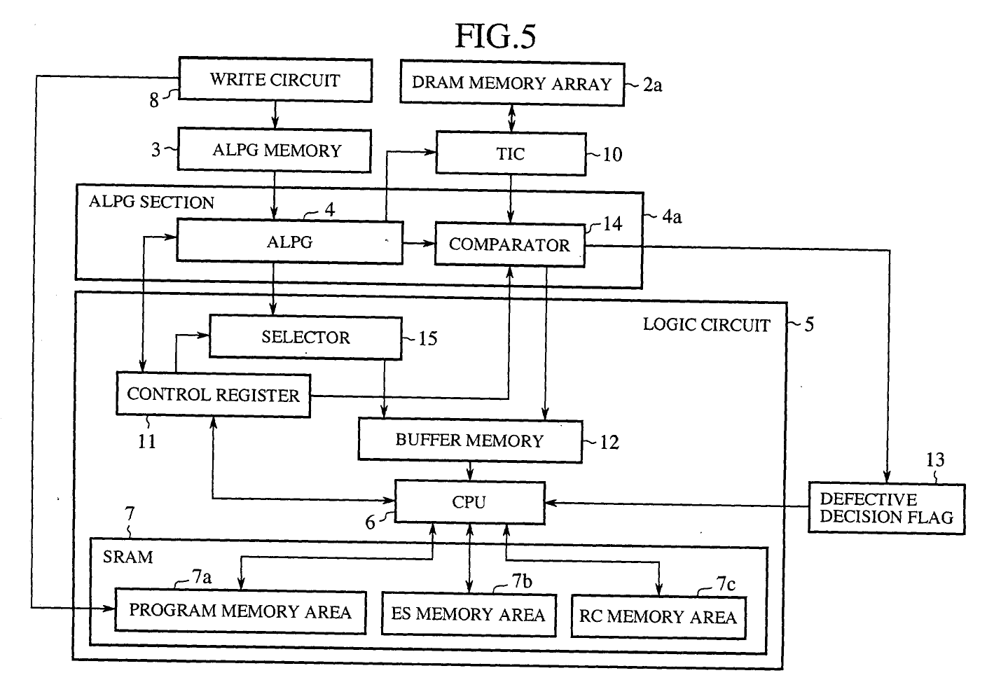

FIG. 4 is a block diagram showing a schematic configuration of an embodiment 2 of the semiconductor integrated circuit in accordance with the present invention; and FIG. 5 is a block diagram showing a configuration for carrying out the repair analysis of the DRAM of the semiconductor integrated circuit in FIG. 4. In these figures, the reference numeral 4a designates an ALPG section including the ALPG 4 and a comparator 14. The reference numeral 13 designates a defective decision flag at which the presence or absence of a defect is set for each block (called analysis block from now on) corresponding to a given repair unit of the DRAM memory array 2a. The reference numeral 14 designates the comparator constituting the ALPG section 4a. It compares the output data fed from the DRAM with the expected values to make a defective decision. The reference numeral 15 designates a selector for receiving the address information about the defective memory cell, and for obtaining the address information about the analysis block including the address information. In FIGS. 1 and 2, the same components are designated by the same reference numerals and the description thereof is omitted here.

Next, the operation of the present embodiment 2 will be described.

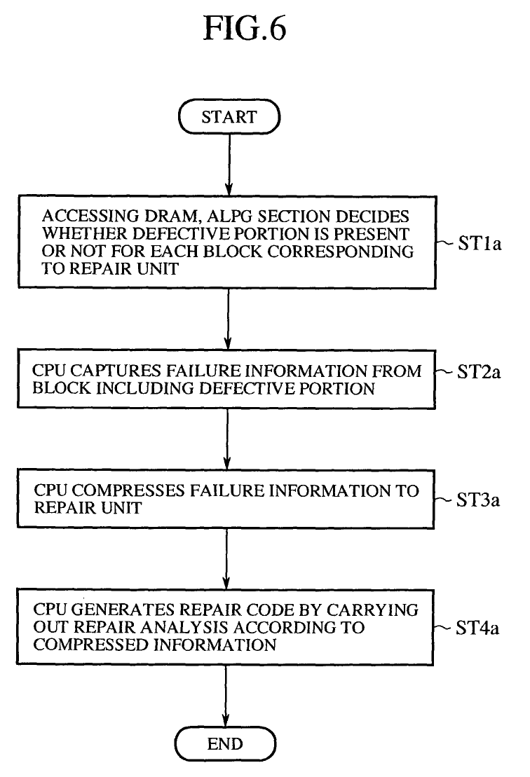

FIG. 6 is a flowchart illustrating the operation of the semiconductor integrated circuit in FIG. 4, with reference to which the repair analysis of the DRAM will be described.

First, the write circuit 8 loads the information necessary for the test such as the test program in accordance with the test specification from the external test device such as the LSI tester. Subsequently, the write circuit 8 writes the input test program in the ALPG memory 3 and program memory area 7a in the SRAM 7 as the execution code (so-called the machine code) of the ALPG 4 and CPU 6. The write operation is performed in accordance with the data write rate of the external test device.

Subsequently, receiving the test start request from the outside, the CPU 6 sets into the specified bits of the control register 11 the logic values designating the access pattern program and test vector in accordance with the test specification corresponding to the request, and the logic value designating the start of the test. Thus, the ALPG 4 reads the test program corresponding to the specification from the ALPG memory 3 and executes it, and accesses the DRAM memory array 2a by generating the access timing and test pattern data according to the test program. It is assumed here that the ALPG 4 iterates the read/write access to each memory cell of the DRAM memory cell array. The concrete operation is the same as that of the foregoing embodiment 1.

Subsequently, after multiple times of accesses to a single memory cell have been completed, the comparator 14 detects the data stored in the memory cell specified by the address signal fed from the ALPG 4, and loads the data as the output data from the memory cell. The comparator 14 logically compares the output data with the expected value data fed from the ALPG 4. If the two data disagree, the comparator 14 makes a decision that a defect is detected for the analysis block, and sets in the defective decision flag 13 the information indicating that the analysis block including the memory cell is defective (step ST1a).

At the same time, the ALPG 4 transfers the address information about the defective memory cell to the selector 15. Sequentially receiving the address information about the defective memory cells, the selector 15 obtains the address information specifying the current analysis block from the address information about the defective memory cells included in the same analysis block, and stores it in the buffer memory 12.

After the ALPG 4a has completed the series of accesses to the DRAM, the CPU 6 obtains the relationships between the individual memory cells in the defective analysis block and the expected values of the response output by analyzing the test program stored in the program memory area 7a, referring to the content in the defective decision flag 13 and the address information about the analysis block stored in the buffer memory 12. Then, using the address information about the individual memory cells in the defective analysis block, the CPU 6 rereads the data only from the individual memory cells in the defective analysis block. The data sequentially read from the individual memory cells are temporarily stored in the buffer memory 12.

Subsequently, the CPU 6 reads the output data of the memory cells sequentially from the buffer memory 12, and compares them with the expected values of the corresponding response output. If they disagree, the CPU 6 makes a decision that the memory cell is defective, and sequentially stores the failure information about the defective memory cell in the ES memory area 7b in the SRAM 7 in connection with the address information about the analysis block (step ST2a: defective decision step) Subsequently, the CPU 6 executes the repair analysis program stored in the program memory area 7a separately from the test program, thereby generating from the contents stored in the ES memory area 7b the compressed failure information obtained for the defective analysis block by compressing the failure information into the repair unit (step ST3a: defective decision step). For example, if a particular analysis block includes a plurality of defective memory cells, the failure information can be compressed by replacing the failure information by a piece of data representing the failure information about the analysis block. The compressed information thus obtained is stored in the ES memory area 7b in the series of the operations in the read access.

Subsequently, the CPU 6 carries out the test of all the defective analysis blocks (including the spare cells), and sequentially stores the failure information in the ES memory area 7b as the compressed information. Completing the test of all the defective analysis blocks, the CPU 6 analyzes the compressed information stored in the ES memory area 7b to obtain the repair code (including the repair code for the spare cells) for designating the location in the LT-fuses 9 to be subjected to the laser trimming (step ST4a: repair analysis step). The repair code is stored in the RC memory area 7c of the SRAM 7.

Subsequently, the repair code in the RC memory area 7c is read by the external test device such as the LSI tester to carry out the actual defective repair.

As described above, the present embodiment 2 is configured such that the CPU 6 executes the detailed defective decision and repair analysis only for the defective analysis blocks extracted by the defective decision on the DRAM by the ALPG section 4a. As a result, the present embodiment 2 can eliminate the processing time for the nondefective analysis block, thereby being able to reduce the test time period.

Embodiment 3

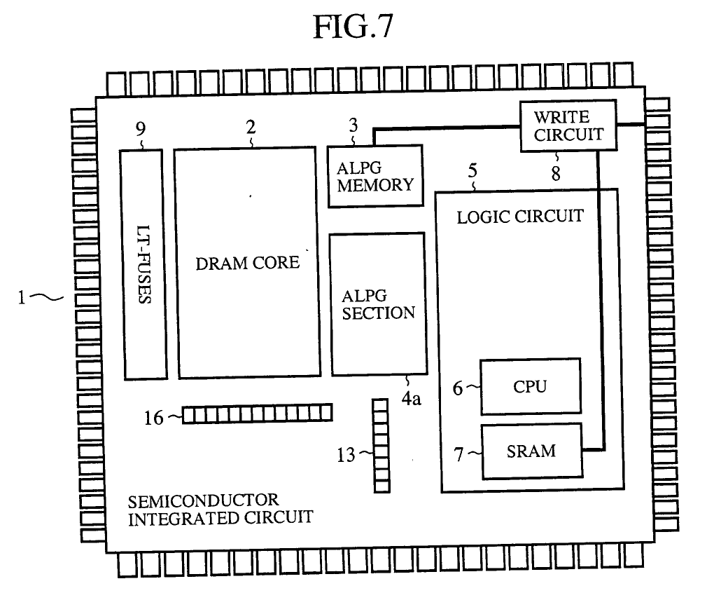

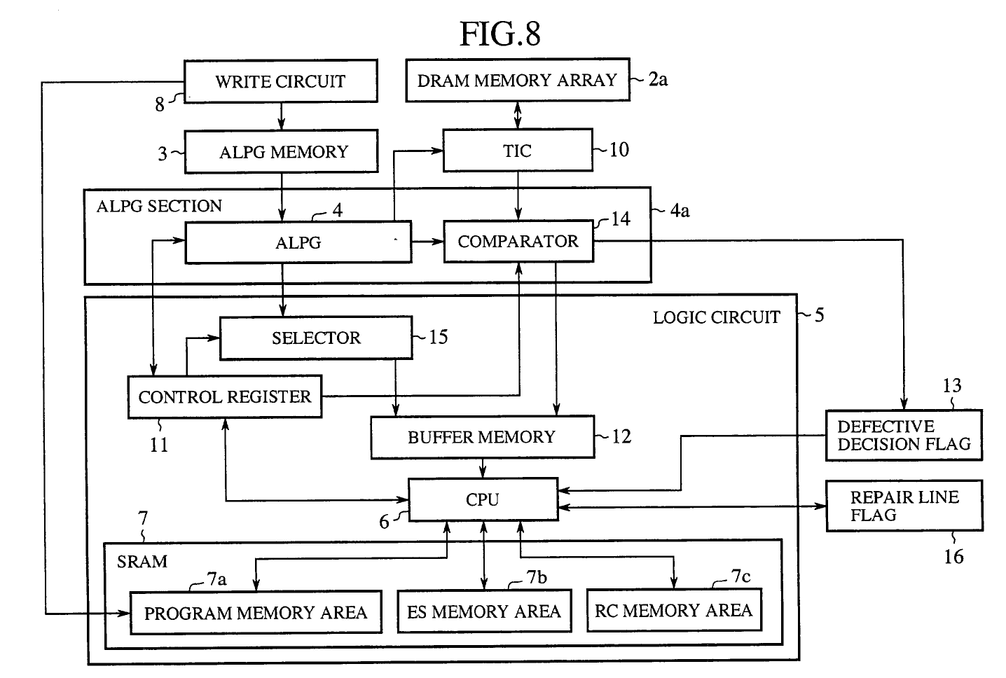

FIG. 7 is a block diagram showing a schematic configuration of an embodiment 3 of the semiconductor integrated circuit in accordance with the present invention, and FIG. 8 is a block diagram showing a configuration for carrying out the repair analysis of the DRAM of the semiconductor integrated circuit in FIG. 7. In these figures, the reference numeral 16 designates a repair line flag to which the information is set which indicates whether a word line or bit line in the DRAM memory array 2a includes a predetermine number or more defective memory cells. The same components as those of FIGS. 1 and 4 are designated by the same reference numerals and the description thereof is omitted here.

Next, the operation of the present embodiment 3 will be described.

First, the write circuit 8 loads the information necessary for the test such as the test program in accordance with the test specification from the external test device such as the LSI tester. Subsequently, the write circuit 8 writes the input test program in the ALPG memory 3 and program memory area 7a in the SRAM 7 as the execution code (so-called the machine code) of the ALPG 4 and CPU 6. The write operation is performed in accordance with the data write rate of the external test device.

Subsequently, receiving the test start request from the outside, the CPU 6 sets into the specified bits of the control register 11 the logic values designating the access pattern program and test vector in accordance with the test specification corresponding to the request, and the logic value designating the start of the test. Thus, the ALPG 4 reads the test program corresponding to the specification from the ALPG memory 3 and executes it, and accesses the DRAM memory array 2a by generating the access timing and test pattern data according to the test program. It is assumed here that the ALPG 4 iterates the read/write access to each memory cell of the DRAM memory cell array. The concrete operation is the same as that of the foregoing embodiment 1.

Subsequently, after multiple times of accesses to a single memory cell have been completed, the comparator 14 detects the data stored in the memory cell specified by the address signal fed from the ALPG 4, and loads the data as the output data from the memory cell. The comparator 14 logically compares the output data with the expected value data fed from the ALPG 4. If the two data disagree, the comparator 14 makes a decision that a defect is detected for the analysis block, and sets in the defective decision flag 13 the information indicating that the analysis block including the memory cell is defective.

At the same time, the ALPG 4 transfers the address information about the defective memory cell to the selector 15. Sequentially receiving the address information about the defective memory cell, the selector 15 obtains the address information specifying the analysis block from the address information about the defective memory cell included in the same analysis block, and stores it in the buffer memory 12. The processing so far is the same as that of the foregoing embodiment 2.

Furthermore, the CPU 6 is sequentially supplied with the failure information from the ALPG 4 and comparator 14 via the buffer memory 12. Using the failure information, the CPU 6 sets into the repair line flag 16 the information identifying a line including a word line or bit line in the DRAM memory array 2a, which includes two or more defective memory cells, for example.

After the ALPG 4a has completed the series of accesses to the DRAM, the CPU 6 executes the repair analysis program that is stored in the program memory area 7a separately from the test program. Thus, the CPU 6 performs the repair analysis for deciding the substitute line for the line which is set into the repair line flag 16, and stores the result into the ES memory area 7b.

Subsequently, the CPU 6 obtains the relationships between the individual memory cells in the defective analysis block and the expected values of the response output by analyzing the test program stored in the program memory area 7a, referring to the contents of the repair line flag 16 and defective decision flag 13, and to the address information about the analysis block stored in the buffer memory 12. Then, the CPU 6 reads the data only from the individual memory cells in the defective analysis block. In this case, the CPU 6 does not read the data from the memory cells on the line which are set in the repair line flag 16, or make a defective decision as to these memory cells.

Subsequently, the CPU 6 reads the output data of the memory cells sequentially from the buffer memory 12 as in the foregoing embodiment 2, and compares them with the expected values of the corresponding response output. If they disagree, the CPU 6 makes a decision that the memory cell is defective, and sequentially stores the failure information about the defective memory cell in the ES memory area 7b in the SRAM 7 in connection with the address information about the analysis block (defective decision step).

Subsequently, as for the failure information other than the failure information about the lines set in the repair line flag 16, the CPU 6 generates the compressed information from the contents stored in the ES memory area 7b just as in the foregoing embodiment 2. The compressed information thus obtained is stored in the ES memory area 7b.

Subsequently, the CPU 6 carries out the test of the defective analysis blocks (including the spare cells) other than those associated with the lines set in the repair line flag 16, and sequentially stores the failure information in the ES memory area 7b as the compressed information. Completing the test, the CPU 6 analyzes the substitute line information and compressed information stored in the ES memory area 7b to obtain the repair code (including the repair code for the spare cells) for designating the location in the LT-fuses 9 to be subjected to the laser trimming (repair analysis step). The repair code is stored in the RC memory area 7c of the SRAM 7.

Finally, the repair code in the RC memory area 7c is read by the external test device such as the LSI tester to carry out the actual defective repair.

As described above, the present embodiment 3 is configured such that it includes the repair line flag 16 for identifying the line including a predetermined number or more defective memory cells, and carries out the repair analysis without making a detailed defective decision of the line. As a result, the present embodiment 3 can reduce the time period required for the repair analysis, and hence reduce the test time.

Although the embodiment 3 applies the repair line flag 16 to the configuration of the foregoing embodiment 2, this is not essential. For example, the repair line flag 16 is applicable to the foregoing embodiment 1 so that the CPU 6 makes the defective decision and sets the repair line flag 16 to offer the same advantages.

What is claimed is:

1. A semiconductor integrated circuit comprising:
a semiconductor memory including a plurality of memory cells and a redundancy section for replacing a defective portion;
a test access section for writing test data to and reading the test data from each memory cell in said semiconductor memory when an operation mode is set at a test mode;
a central processing unit for locating the defective portion in said semiconductor memory and for analyzing the redundancy section for replacing the defective portion by rereading data held in the memory cell when said test access section writes the test data to and reads the test data from the memory cell; and
a storing section for storing execution code of the operation, a defective decision result and an analysis result in the test mode of said central processing unit.

2. The semiconductor integrated circuit according to claim 1, further comprising a comparator for comparing the data held in the memory cell with an expected value of the data when said test access section writes the data to and reads the data from the memory cell; and a defective decision flag to which presence and absence of a defect is set for each memory block corresponding to a substitute unit of said redundancy section, wherein
said central processing unit rereads the data only from the memory cells in the memory block which is set in said defective decision flag as having a defect because a compared result by said comparator indicates disagreement, locates the defective portion in said memory block, and analyzes the redundancy section for replacing the defective portion.

3. The semiconductor integrated circuit according to claim 1, wherein
said semiconductor memory includes bit lines and word lines placed in rows and columns, and a plurality of memory cells disposed at intersections of the rows and columns, wherein
said semiconductor integrated circuit further comprises a repair line flag for recording information for identifying a bit line and/or word line including at least a predetermined number of defective portions when said test access section writes the data to and reads the data from the memory cells, and wherein
said central processing unit analyzes the redundancy section for replacing the bit line and/or word line recorded in said repair line flag, first, and skips a location decision of the defective portion of the bit line and/or word line.
